(19) United States
(12) Patent Application Publication
(10) Pub. No.: US 2002/0124268 A1
(43) Pub. Date: Sep. 5, 2002

(54) Television programming with variable ancillary information

(76) Inventors: Aditya Krishnan, San Diego, CA (US); Matthew S. Chang, San Diego, CA (US); Andrew M. Proehl, San Francisco, CA (US); David K. L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/753,430

(22) Filed: Jan. 3, 2001

(51) Int. Cl. H04N 7/173; H04N 7/16; H04N 7/08

(52) U.S. Cl. 725/139; 725/109; 348/473

(57) ABSTRACT

A method and apparatus for presenting variable pop-up windows of ancillary information in television programming. Multiple instances of ancillary information is transmitted to a set-top box in association with segments of programming content. The set-top box selects a different set of ancillary information for display in a pop-up window whenever the content is presented. In one embodiment, a different set of ancillary information is presented according to the number of times the programming is presented. In another embodiment, ancillary information is selected using a randomizing algorithm.

### FIELD OF THE INVENTION

This invention relates generally to the field of interactive television. More particularly, this invention relates to a method and apparatus for providing television programming with variable ancillary information.

### BACKGROUND OF THE INVENTION

Television set-top boxes were initially introduced to provide tuning capabilities for cable and satellite television systems. While these devices still provide that fundamental function, the latest generation of digital set-top boxes now often incorporate powerful computers. With such computers available, and with the low cost necessitated by the high volume production of such devices, it is now possible to expand the usefulness of the television set-top box beyond that of merely providing tuning functions for cable and satellite systems.

The television program “Pop-Up Videos” was recently introduced in which music videos are presented with commentary overlaid thereon. Such information is presented to the viewer in the form of windows or bubbles that overlay the screen image and contain text about, for example, the artist or the music being presented to the viewer. This programming is believed to be created by editing a copy of the original video content to superimpose the windows or bubbles of information at appropriate locations.

This popular program is widely enjoyed by viewers wishing to find out additional information about an artist or musical selection. Moreover, it provides an avenue to inexpensively reuse entertainment content while providing the viewer with a new product. In many instances, the additional ancillary information overlaid upon the original video may be of greater interest to the viewer than the original video, and thus, may attract viewers who are uninterested in the pure video itself.

Unfortunately, while the viewer may be interested in the initial viewing of a video, or the initial viewing of the modified video with pop-up information overlaid thereon, the viewer is likely to be subjected to either or both of the videos repeatedly. The viewer may thus become weary of viewing the same video or ancillary information repeatedly. The present invention is intended to address this issue in an invention that can be widely adapted to music videos as well as conventional television programming and pay-per view programming.

### SUMMARY OF THE INVENTION

The present invention relates generally to interactive television. Objects, advantages and features of the invention will become apparent to those skilled in the art upon consideration of the following detailed description of the invention.

In one embodiment of the present invention, a method and apparatus for presenting variable pop-up windows of ancillary information in television programming is provided. Multiple instances of ancillary information is transmitted to a set-top box in association with segments of programming content. The set-top box selects a different set of ancillary information for display in a pop-up window whenever the content is presented. In one embodiment, a different set of ancillary information is presented according to the number of times the programming is presented. In another embodiment, ancillary information is selected using a randomizing algorithm.

A method of presenting entertainment program material consistent with an embodiment of the invention includes: presenting a first presentation of a segment of programming having a first window overlaying the segment of programming, the first window containing a first segment of ancillary information relevant to the segment of programming; and presenting a second presentation of the segment of programming having a second window overlaying the segment of programming, the second window containing a second segment of ancillary information relevant to the segment of programming.

A method of presenting entertainment program material consistent with another embodiment of the invention includes the unordered process of: presenting a first presentation of a segment of programming having a first window overlaying the segment of programming, the first window containing a first segment of ancillary information relevant to the segment of programming; and presenting a second presentation of the segment of programming having no second window overlaying the segment of programming.

A method of presenting entertainment program material according to another embodiment includes: presenting a first presentation of a segment of programming having a static window overlaying the segment of programming, the static window containing a static segment of ancillary information relevant to the segment of programming; and presenting a second presentation of the segment of programming having a second window overlaying the segment of programming, the second window containing a variable segment of ancillary information relevant to the segment of programming.

A television set-top box consistent with certain embodiments includes a receiver for receiving signals representing segments of programming and signals representing a plurality of segments of ancillary information, and delivering the signals representing segments of programming to a display interface. A central processor is programmed to carry out a process of delivering a first presentation of a segment of programming having a first window overlaying the segment of programming to the display interface, the first window containing a first segment of ancillary information relevant to the segment of programming; and delivering a second presentation of the segment of programming having a second window overlaying the segment of programming to the display interface, the second window containing a second segment of ancillary information relevant to the segment of programming.

A television set-top box consistent with another embodiment of the invention includes a receiver for receiving signals representing segments of programming and signals representing a plurality of segments of ancillary information, and delivering the signals representing segments of programming to a display interface.

A central processor is programmed to deliver a first presentation of a segment of programming having a first window overlaying the segment of programming to the display interface, the first window containing a first segment of ancillary information relevant to the segment of programming; and deliver a second presentation of the segment of programming having no second window overlaying the segment of programming to the display interface.

In yet another embodiment of a television set-top box consistent with the invention, a receiver for receives signals representing segments of programming and signals representing a plurality of segments of ancillary information, and delivering the signals representing segments of programming to a display interface. A central processor is programmed to deliver a first presentation of a segment of programming having a static window overlaying the segment of programming to the display interface, the static window containing a static segment of ancillary information relevant to the segment of programming; and deliver a second presentation of the segment of programming having a second window overlaying the segment of programming to the display interface, the second window containing a variable segment of ancillary information relevant to the segment of programming.

In another embodiment, a storage medium storing instructions which, when executed on a programmed processor, carry out a method of presenting entertainment program material including presenting a first presentation of a segment of programming having a first window overlaying the segment of programming, the first window containing a first segment of ancillary information relevant to the segment of programming; and presenting a second presentation of the segment of programming having a second window overlaying the segment of programming, the second window containing a second segment of ancillary information relevant to the segment of programming.

In another embodiment, a storage medium storing instructions which, when executed on a programmed processor, carry out a method of presenting entertainment program material, including the unordered process of: presenting a first presentation of a segment of programming having a first window overlaying the segment of programming, the first window containing a first segment of ancillary information relevant to the segment of programming; and presenting a second presentation of the segment of programming having no second window overlaying the segment of programming.

In another embodiment, a storage medium storing instructions which, when executed on a programmed processor, carry out a method of presenting entertainment program material including presenting a first presentation of a segment of programming having a static window overlaying the segment of programming, the static window containing a static segment of ancillary information relevant to the segment of programming; and presenting a second presentation of the segment of programming having a second window overlaying the segment of programming, the second window containing a variable segment of ancillary information relevant to the segment of programming.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 depicts an exemplary screen image with a first pop-up window containing ancillary information.

FIG. 4 depicts an exemplary screen image with a second pop-up window containing ancillary information.

FIG. 5 depicts an exemplary screen image with a third pop-up window containing ancillary information.

FIG. 6 depicts an exemplary screen image with a fourth pop-up window containing ancillary information.

FIG. 7 is a flow chart describing a first embodiment of the present invention.

FIG. 8 is a flow chart describing a second embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

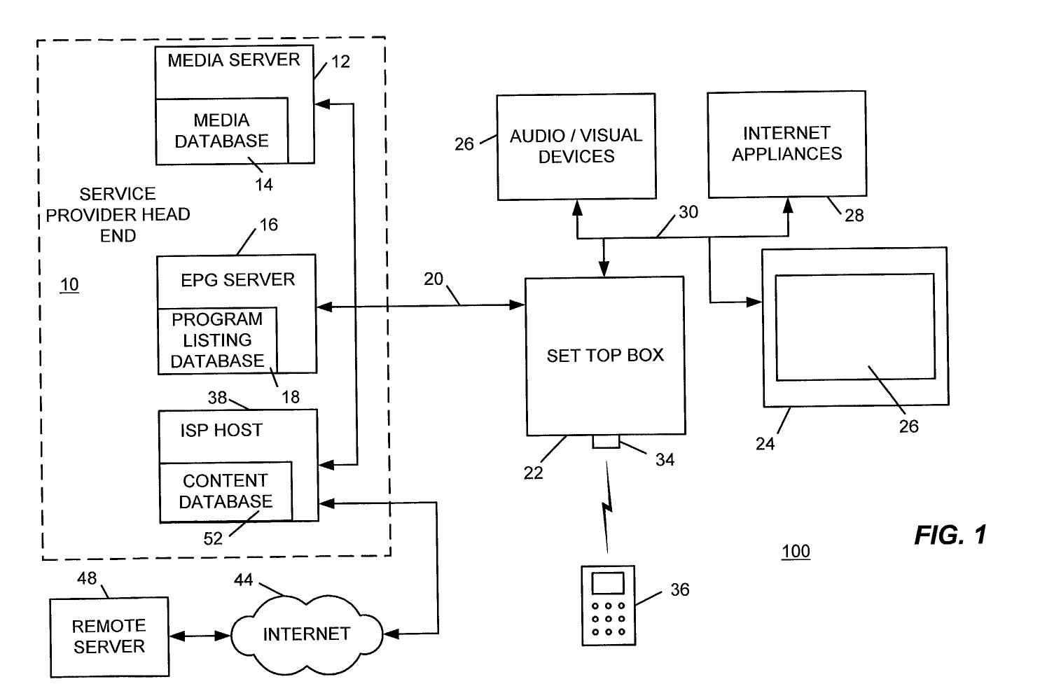

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, Nov. 1999.

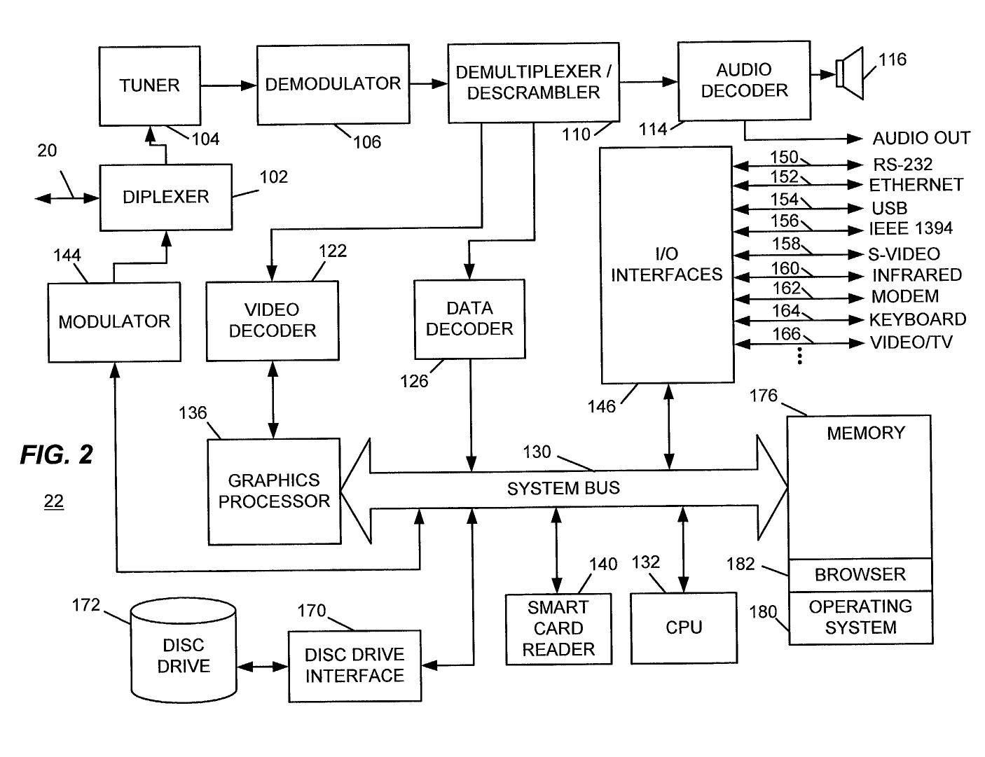

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RA/ drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

In accordance with the present invention, a pop-up window is used to carry ancillary information associated with television programming. This ancillary information can be encoded within the television signal in any suitable manner. For example, the information can be encoded within the vertical or horizontal blanking intervals in one embodiment, and in another embodiment, the information can be encoded using any of the current or emerging standards for embedding information into a digital television information stream without limitation. The terms “window” and “pop-up window” as used herein are intended to embrace areas of the television screen which are overlaid with rectangles, bubbles, ovals or other shapes containing textual or graphical information.

In various advanced television proposals, such as the ATVEF (Advanced TeleVision Enhancement Forum) proposal, it is possible to embed information such as Internet addresses and other ancillary information within a television signal. Such ancillary information can be decoded at the television set and used for various purposes. Additionally, a technique for providing such information is now available and in use by Wink Communications of Alameda, Calif. to embed ancillary information into “Wink™ Enabled” television programming. Techniques such as these can be utilized to provide the viewer's set-top box with the ancillary information used in accordance with the present invention.

In accordance with the present invention, the viewer is presented with pop-up windows during viewing of a television program. The ancillary information contained within the pop-up windows changes in any of a plurality of ways depending upon the algorithm selected for implementation. Those skilled in the art will recognize many possible algorithms that are suitable for implementing the present invention, with the constraint that the user is presented with varying content within pop-up windows whenever the program is viewed. The term program is used loosely herein to represent any television content such as a conventional program, movie, pay-per-view event or even segments of a program (e.g. as in music videos making up a program of a collection of such music videos).

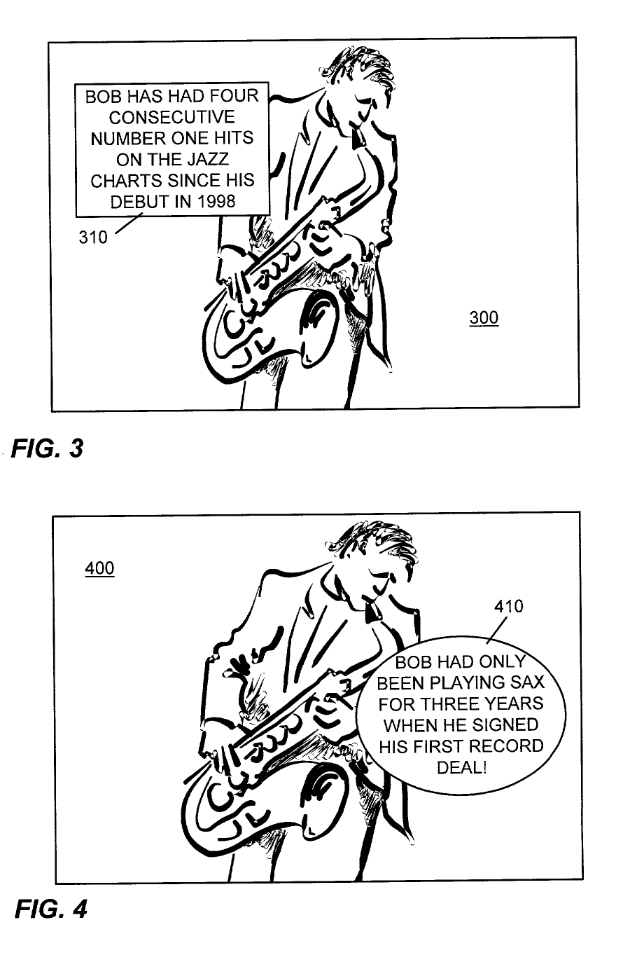

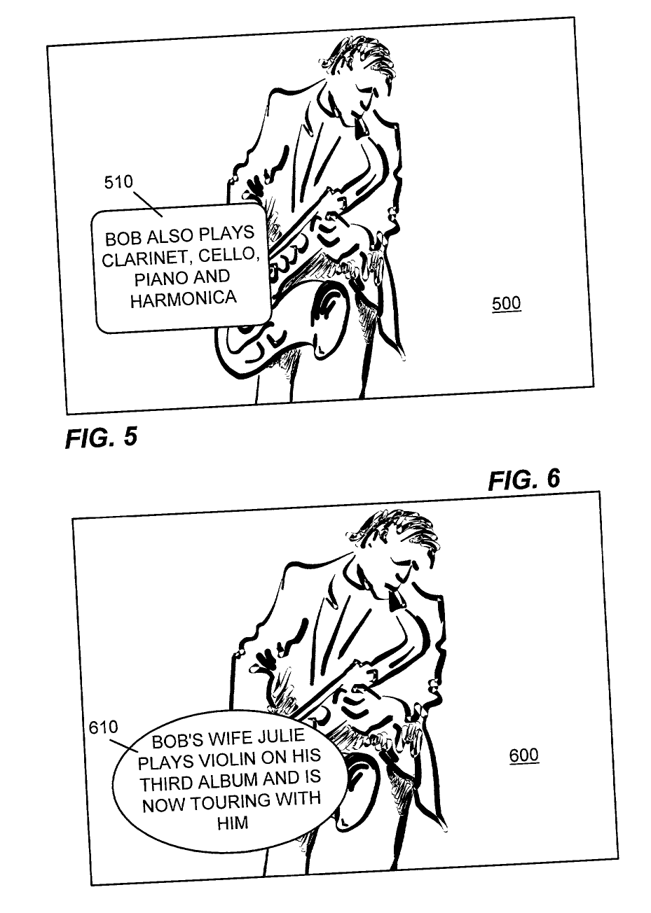

An example of the present invention is illustrated in the simulated screen images of FIGS. 3-6. In each of these images, the program content (in this example a music video portraying a jazz saxophone player) remains the same. But, each time the video is viewed, the pop-up window displays a different segment of ancillary information. In FIG. 3, the screen image 300 portrays the performer at a particular time in the program with pop-up window 310 providing a segment of ancillary information regarding his sequence of hits. In FIG. 4, the screen image 400 portrays the performer at the same particular time in the program with pop-up window 410 providing a segment of ancillary information regarding his experience in playing the saxophone. In FIG. 5, the screen image 500 portrays the performer at the same particular time in the program with pop-up window 510 providing a segment of ancillary information regarding his other musical skills besides saxophone. Finally, in FIG. 6, the screen image 600 portrays the performer, again at the same particular time in the program, with pop-up window 610 providing a segment of ancillary information regarding his wife's musical career. While four examples are shown, this should not be considered limiting.

As illustrated, the same segment of video can be used to trigger a different set of ancillary information to be displayed to a viewer on different viewings of the program material. In this example, not only is the ancillary information appearing in the window varied, but the location of the window and shape of the window is also varied to further enhance the interest level. In other embodiments, the shape, size and location of the window can be static or can be varied along with the varying of the ancillary information, as desired in implementation. In this example also, the ancillary information always appears at the same location in the program, but this too is not to be limiting. Information can be randomly or systematically displayed in a manner that varies from viewing to viewing without departing from the invention.

In order to accomplish this, the ancillary information in the preferred embodiment is transmitted to the set-top box using any suitable technique and stored in local storage (e.g. the disc drive 172 or memory 176) for later retrieval and merging with the programming content during playback. This transmission can be carried out prior to the programming or during the programming. In accordance with one embodiment, when a marker is reached in the video signal, the set-top box processor 132, under program control, places the ancillary information in a window that it then overlays on the program information by superimposing the window over the video information in a known manner and delivers the combined information (programming segment plus window containing ancillary information) it to the display interface (e.g. 156 or 166). (In other embodiments, the ancillary information may include insertion times or frames for the insertion of the window.)

The marker may include various information used by the programmed processor 132 to insert the proper pop-up window on the screen. For example, the marker may include a popup location identifier that uniquely identifies a location in the program so that the marker can be matched with a suitable pop-up window of ancillary information. The marker may also determine the size and location of the pop-up window, or this can be otherwise determined.

Upon reaching a pop-up marker in the video stream, the programmed processor 132 retrieves a suitable segment of ancillary information for insertion into the video stream. In accordance with one illustrative embodiment, the programmed processor looks up the already received ancillary information in a table stored on the disc drive 172. The table may contain information similar to that of TABLE 1. TABLE 1 below illustrates a portion of the table containing information relating to the pop-up windows illustrated in FIGS. 3-6 shown previously. In this example, the pop-up window is located in location number 8 in the programming segment. A plurality of segments of ancillary information is illustrated including segments 1, 2, 3 and 4 corresponding to 310, 410, 510 and 510 of FIGS. 3-6. Additionally, in this embodiment, TABLE 1 includes a time duration for display of the ancillary information. In other embodiments, this can be represented by an ending frame number. In still other embodiments, a video marker is not used at all. Instead, TABLE 1 would contain a starting frame number and an ending frame number or a starting run time and an ending run time that would determine when the ancillary information is presented to the viewer, as will be described later.

TABLE I

| POP-UP | POP-UP | DURA- | ANCILLARY |
|---|---|---|---|
| LOCATION | SEGMENT | TION OF | INFORMATION |
| IDENTIFIER | IDENTIFIER | POP-UP | IN POP-UP WINDOW |
| . . . | . . . | . . . | . . . |
| 7 | . . . | . . . | . . . |
| 8 | 1 | 8.0 | BOB HAS HAD FOUR |
| | | seconds | CONSECUTIVE |
| | | | NUMBER ONE HITS |
| | | | ON THE JAZZ CHARTS |
| | | | SINCE HIS DEBUT IN |
| | | | 1998 |
| 8 | 2 | 7.5 | BOB HAD ONLY BEEN |
| | | seconds | PLAYING SAX FOR |
| | | | THREE YEARS WHEN |
| | | | HE SIGNED HIS FIRST |
| | | | RECORD DEAL! |
| 8 | 3 | 6.0 | BOB ALSO PLAYS |
| | | seconds | CLARINET, CELLO, |
| | | | PIANO AND |
| | | | HARMONICA |
| 8 | 4 | 7.5 | BOB'S WIFE JULIE |
| | | seconds | PLAYS VIOLIN ON HIS |
| | | | THIRD ALBUM AN IS |
| | | | NOW TOURING WITH |
| | | | HIM |
| 8 | . . . | . . . | . . . |
| 9 | . . . | . . . | . . . |
| . . . | . . . | . . . | . . . |

The above information presented in TABLE 1, is intended to be illustrative of the type of information transmitted as the ancillary data and should not be considered limiting. The ancillary data could also include information determining the location and shape of the window, starting frame number, ending frame number and/or other information without departing from the invention.

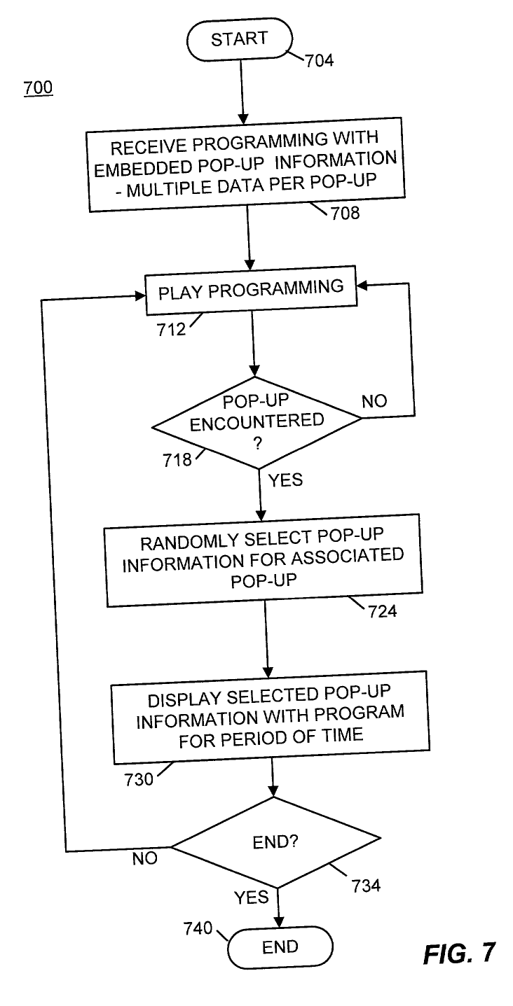

Referring now to FIG. 7, an embodiment of the present invention is illustrated as process 700 starting at 704. At 708, the programming is received including embedded ancillary information. At this point, it is assumed that the needed ancillary information has been received by the set-top box 22 in advance of the time it should be displayed. At 712, the programming content is started and played until the appropriate time for a pop-up window containing an ancillary information segment is reached at 718. This can be determined by receiving a marker in the segment of programming as illustrated in TABLE 1 (or alternatively by reaching a frame number or run time corresponding to an appropriate time for the pop-up window to appear). When the appropriate time is reached for a pop-up window to be displayed at 718, the programmed processor randomly selects from the available pop-up ancillary information segments available for presentation at this time at 724 (e.g. any of the segments associated with a given pop-up location identifier or pop-up start time or frame). This ancillary information is then overlaid on the programming segment at 730 for a predetermined period of time. This process repeats until the end of the programming segment is reached at 734 and the process ends at 740.

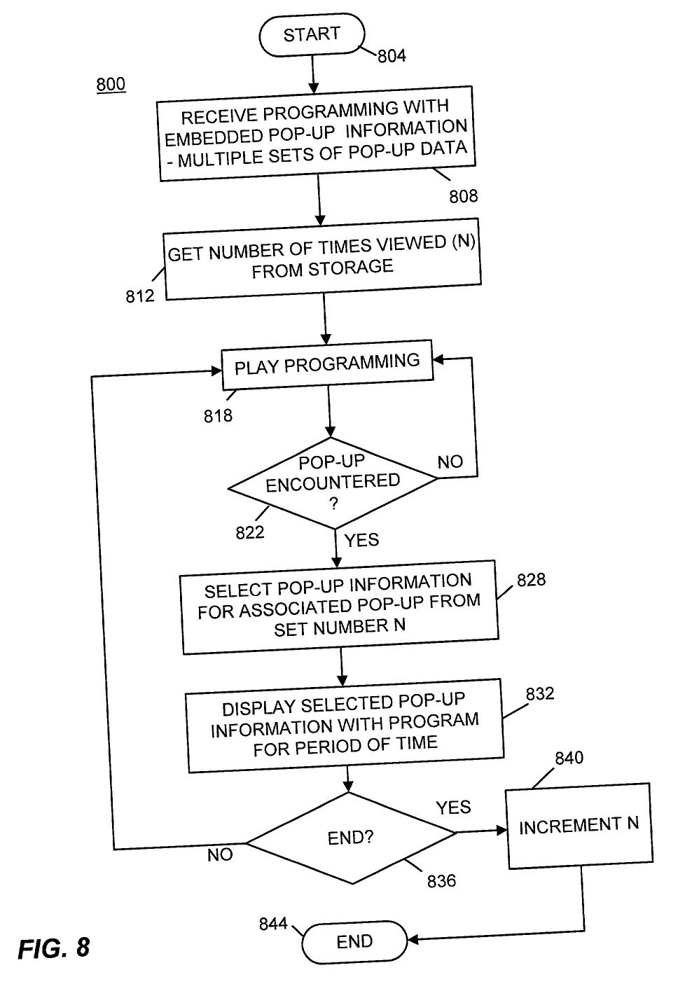

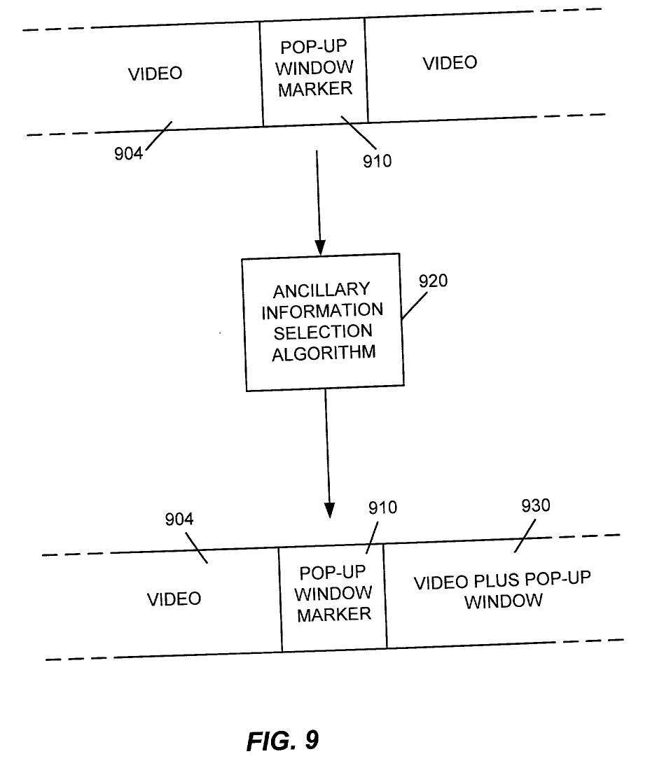

Referring now to FIG. 8 in conjunction with TABLE 2 below, another embodiment of the present invention is illustrated as process 800 starting at 804. In this embodiment, the ancillary information is arranged in sets of data, but those skilled in the art will appreciate that TABLE 2 contains equivalent information to that of TABLE 1 except it is presented in a different arrangement for ease of understanding and to illustrate another technique for starting and stopping the pop-up window. At 808, the receipt of the program content at the set-top box starts including information such as that in TABLE 2 representing multiple sets of ancillary data (set 1, set 2, . . . etc.). In this example, the set-top box records the number of times a particular programming segment has been previously viewed. This can be tracked by creating an identifier for each relevant programming segment and storing this information in a database in disc drive 172, for example. At 812, the set-top box determines the nature of the programming segment being viewed and determines how many times the segment has been viewed previously (N). The programming commences play at 818 until time for a pop-up window of information as determined, in this example, by a frame number for a digital television image being displayed at 822. By way of example, if frame number 123, 456 has been reached and this is the 5^{th} time this programming segment has been viewed (i.e. N=5), the pop-up window 510 of FIG. 5 is displayed in accordance with the entry points of TABLE 2 defined by the frame number and N.

Thus, at 828, the appropriate ancillary information segment is selected for presentation in the pop-up window at 832 until the end frame number (in this example, 123, 636) is reached. This process continues until the end of the programming is reached at 836. At this point, the counter N is incremented in the database by the programmed processor 132 at 840 and the process ends at 844. Of course those skilled in the art will appreciate that many variations are possible without departing from the invention. For example, the counter can be incremented at another location or the start and stop time can be varied. Moreover, the size, shape and location of the pop-up window can be varied (either by reference to data in the table, or by random creation of the window by processor 132 or server 12, for example) without departing from the invention.

Note that one variation of the present embodiment is illustrated at frame 123, 456 for set number 6. In this variation, which could be represented in many ways including a total lack of information associated with frame 123, 456, no ancillary information is provided. In this manner, not only can the content of the pop-up window be varied, the windows can apparently appear at different places in each presentation of the segment of programming. That is, for example, a given segment of programming might include 30 pop-up windows. But, 90 pop-up window locations can be defined with only 30 used in any given presentation of the segment of programming with hundreds of segments of ancillary information stored and available for viewing. In this manner, not only is the viewer presented with different ancillary information each time the segment of programming is viewed, but additionally, the pop-up windows appear in unpredictable locations each time.

While the processes of FIGS. 7 and 8 have been described in terms of a system in which the ancillary information segments are selected for display at STB 22 using programmed processor 132, this should not be considered limiting. In another embodiment, either process, or similar processes, can be carried out at the service provider or other program broadcaster. In such embodiments, for example, media server 12 of service provider 10 includes the ancillary information along with the programming content in database 14. A programmed processor within media server 12 then merges the ancillary information into appropriate pop-up windows in accordance with any suitable random or systematic algorithm, and the merged information is then broadcast to the subscribers' STBs. The process can be carried out as a batch job or dynamically as the broadcast occurs. In the case of the process using multiple sets of ancillary data, a new set can be selected for each broadcast rather than for each reception as previously described. Many variations will occur to those skilled in the art without departing from the invention.

TABLE 2

| POP-UP | START | END | |
|---|---|---|---|
| SET | FRAME | FRAME | ANCILLARY INFORMATION |
| IDENTIFIER | NUMBER | NUMBER | IN POP-UP WINDOW |
| . . . | . . . | . . . | . . . |
| 2 | . . . | . . . | . . . |
| . . . | . . . | . . . | . . . |
| 3 | 123,456 | 123,696 | BOB HAS HAD FOUR |
| | | | CONSECUTIVE NUMBER |
| | | | ONE HITS ON THE JAZZ |
| | | | CHARTS SINCE HIS DEBUT |
| | | | IN 1998 |
| . . . | . . . | . . . | . . . |
| 4 | 123,456 | 123,681 | BOB HAD ONLY BEEN |
| | | | PLAYING SAX FOR THREE |
| | | | YEARS WHEN HE SIGNED |
| | | | HIS FIRST RECORD DEAL! |
| . . . | . . . | . . . | . . . |
| 5 | 123,456 | 123,636 | BOB ALSO PLAYS |
| | | | CLARINET, CELLO, PIANO |
| | | | AND HARMONICA |
| . . . | . . . | . . . | . . . |
| 6 | 123,456 | 123,456 | |
| . . . | . . . | . . . | . . . |
| 7 | 123,456 | 123,681 | BOB'S WIFE JULIE PLAYS |
| | | | VIOLIN ON HIS THIRD |
| | | | ALBUM AN IS NOW |
| | | | TOURING WITH HIM |
| . . . | . . . | . . . | . . . |

The marker based system discussed previously is illustrated in the diagram of FIG. 9. In this process, a stream of video contains video portions 904 and pop-up window markers 910. Upon encountering a marker at 910, the programmed processor 132 or media server 12 selects a segment of ancillary information at 920 using any appropriate algorithm suitable for varying the content of the pop-up windows for the viewer. The processor then modifies the video stream by inserting the pop-up window to produce the modified stream at 930 containing the video signal with the window overlaid thereon. Marker 910 may be removed from the resultant video stream in some embodiments. This video stream 930 can then be processed and viewed in the normal manner.

In another variation of the invention, the sequence of programming can include default pop-up windows that are static (i.e. remain the same on each presentation of the segment of programmed content). The variable ancillary information can then be overlaid on top of the default pop-up windows. Using this embodiment, viewers without a set-top box capable of presenting varying pop-up windows in accord with the present invention can still present the programming content with static pop-up windows. Additionally, broadcasters and service can present the segment of programming without variable pop-up windows if desired or in the event of a system malfunction, or if they lack the capability of presenting the variable pop-up windows of the present invention.

Thus, in accordance with embodiments of the invention, the ancillary information, location of pop-up window on the screen, shape of the window, size of the window, etc. can be varied to present essentially a new viewing experience each time a viewer wishes to view a particular programming segment.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored on an electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of presenting entertainment program material, comprising:
presenting a first presentation of a segment of programming having a first window overlaying the segment of programming, the first window containing a first segment of ancillary information relevant to the segment of programming; and
presenting a second presentation of the segment of programming having a second window overlaying the segment of programming, the second window containing a second segment of ancillary information relevant to the segment of programming.

2. The method according to claim 1, wherein at least the first presenting comprises transmitting the segment of programming to a television set-top box along with the first and second segment of ancillary information.

3. The method according to claim 1, further comprising at a set-top box, selecting the first segment of ancillary information for overlaying in the first presentation and selecting the second segment of ancillary information for overlaying the second presentation.

4. The method according to claim 3, wherein the selecting is carried out by randomly selecting one of the segments of ancillary information.

5. The method according to claim 3, wherein the selecting is carried out by selecting one of the segments of ancillary information in accordance with a number of times the segment of programming has been played at the set-top box.

6. The method according to claim 1, further comprising:
transmitting the segment of programming along with a plurality of segments of ancillary information to a set-top box; and
at the set-top box, selecting the first and second segments of ancillary information for overlaying in the first and second window from the plurality of segments of ancillary information.

7. The method according to claim 6, further comprising counting a number of times the segment of programming is presented to a viewer through the set-top box.

8. The method according to claim 7, further comprising selecting the first and second segments of ancillary information in accordance with the number of times the segment of programming has been previously presented.

9. The method according to claim 6, further comprising selecting the first and second segments of ancillary information in accordance with a random selection process.

10. The method according to claim 1, wherein the first and second windows are of the same size and shape.

11. The method according to claim 1, wherein the first and second windows are of differing sizes and shapes.

12. The method according to claim 1, wherein the first and second windows overlay the same area of the segment of programming.

13. The method according to claim 1, wherein the first and second windows overlay differing areas of the segment of programming.

14. The method according to claim 1, wherein the segment of programming includes a marker indicative of a location for overlaying the window.

15. The method according to claim 1, wherein the first window comprises a default window and wherein the second window overlays the first window.

16. The method according to claim 1, further comprising at a service provider, selecting the first segment of ancillary information for overlaying in the first presentation and selecting the second segment of ancillary information for overlaying the second presentation.

17. The method according to claim 16, wherein the selecting is carried out by randomly selecting one of the segments of ancillary information.

18. The method according to claim 16, wherein the selecting is carried out by selecting one of the segments of ancillary information in accordance with a number of times the segment of programming has been transmitted by the service provider.

19. The method according to claim 1, further comprising:
receiving the segment of programming along with a plurality of segments of ancillary information at a service provider; and
at the service provider, selecting the first and second segments of ancillary information for overlaying in the first and second window from the plurality of segments of ancillary information.

20. The method according to claim 16, further comprising counting a number of times the segment of programming is transmitted from the service provider.

21. The method according to claim 20, further comprising selecting the first and second segments of ancillary information in accordance with the number of times the segment of programming has been previously transmitted.

22. The method according to claim 16, further comprising selecting the first and second segments of ancillary information in accordance with a random selection process.

23. The method according to claim 16, wherein the first window comprises a default window and wherein the second window overlays the second window.

24. A method of presenting entertainment program material, comprising the unordered process of:
presenting a first presentation of a segment of programming having a first window overlaying the segment of programming, the first window containing a first segment of ancillary information relevant to the segment of programming; and
presenting a second presentation of the segment of programming having no second window overlaying the segment of programming.

25. A method of presenting entertainment program material, comprising:
presenting a first presentation of a segment of programming having a static window overlaying the segment of programming, the static window containing a static segment of ancillary information relevant to the segment of programming; and
presenting a second presentation of the segment of programming having a second window overlaying the segment of programming, the second window containing a variable segment of ancillary information relevant to the segment of programming.

26. A television set-top box, comprising:
a receiver for receiving signals representing segments of programming and signals representing a plurality of segments of ancillary information, and delivering the signals representing segments of programming to a display interface;
a central processor;
program means operating on the programmed processor for:
delivering a first presentation of a segment of programming having a first window overlaying the segment of programming to the display interface, the first window containing a first segment of ancillary information relevant to the segment of programming; and
delivering a second presentation of the segment of programming having a second window overlaying the segment of programming to the display interface, the second window containing a second segment of ancillary information relevant to the segment of programming.

27. The apparatus according to claim 26, wherein the selecting is carried out by randomly selecting one of the segments of ancillary information.

28. The apparatus according to claim 27, wherein the selecting is carried out by selecting one of the segments of ancillary information in accordance with a number of times the segment of programming has been presented at the set-top box.

29. The apparatus according to claim 26, further comprising means for counting a number of times the segment of programming is presented to a viewer through the set-top box.

30. The apparatus according to claim 29, further comprising selecting the first and second segments of ancillary information in accordance with the number of times the segment of programming has been previously presented.

31. The apparatus according to claim 26, wherein the first and second windows are of the same size and shape.

32. The apparatus according to claim 26, wherein the first and second windows are of differing sizes and shapes.

33. The apparatus according to claim 26, wherein the first and second windows overlay the same area of the segment of programming.

34. The apparatus according to claim 26, wherein the first and second windows overlay differing areas of the segment of programming.

35. The apparatus according to claim 26, wherein the segment of programming includes a marker indicative of a location for overlaying the window.

36. The method according to claim 26, wherein the first window comprises a default window and wherein the second window overlays the second window.

37. A television set-top box, comprising:
a receiver for receiving signals representing segments of programming and signals representing a plurality of segments of ancillary information, and delivering the signals representing segments of programming to a display interface;
a central processor;
program means operating on the programmed processor for:
delivering a first presentation of a segment of programming having a first window overlaying the segment of programming to the display interface, the first window containing a first segment of ancillary information relevant to the segment of programming; and
delivering a second presentation of the segment of programming having no second window overlaying the segment of programming to the display interface.

38. A television set-top box, comprising:
a receiver for receiving signals representing segments of programming and signals representing a plurality of segments of ancillary information, and delivering the signals representing segments of programming to a display interface;
a central processor;
program means operating on the programmed processor for:
delivering a first presentation of a segment of programming having a static window overlaying the segment of programming to the display interface, the static window containing a static segment of ancillary information relevant to the segment of programming; and
delivering a second presentation of the segment of programming having a second window overlaying the segment of programming to the display interface, the second window containing a variable segment of ancillary information relevant to the segment of programming.

39. A storage medium storing instructions which, when executed on a programmed processor, carry out a method of presenting entertainment program material, comprising:
presenting a first presentation of a segment of programming having a first window overlaying the segment of programming, the first window containing a first segment of ancillary information relevant to the segment of programming; and
presenting a second presentation of the segment of programming having a second window overlaying the segment of programming, the second window containing a second segment of ancillary information relevant to the segment of programming.

40. A storage medium storing instructions which, when executed on a programmed processor, carry out a method of presenting entertainment program material, comprising the unordered process of:
presenting a first presentation of a segment of programming having a first window overlaying the segment of programming, the first window containing a first segment of ancillary information relevant to the segment of programming; and
presenting a second presentation of the segment of programming having no second window overlaying the segment of programming.

41. A storage medium storing instructions which, when executed on a programmed processor, carry out a method of presenting entertainment program material, comprising:
presenting a first presentation of a segment of programming having a static window overlaying the segment of programming, the static window containing a static segment of ancillary information relevant to the segment of programming; and
presenting a second presentation of the segment of programming having a second window overlaying the segment of programming, the second window containing a variable segment of ancillary information relevant to the segment of programming.
